(19) United States
(12) Patent Application Publication
(10) Pub. No.: US 2015/0350340 A1
(43) Pub. Date: Dec. 3, 2015

(54) MANAGEMENT OF HEADLESS HARDWARE IN DATA CENTER

(71) Applicant: Microsoft Corporation, Redmond, WA (US)

(72) Inventors: Paul Stephen Hellyar, Kirkland, WA (US); Chad Wesley Wahlin, Issaquah, WA (US); Kye Hyun Kim, Bellevue, WA (US); Anthony Vincent Discolo, Sammamish, WA (US); John Paul Lynker, JR., Everett, WA (US); Russell Alexander, Seattle, WA (US); Travis J. Muhlestein, Redmond, WA (US); Robert Unoki, Redmond, WA (US); Kenneth Michael Bayer, Kirkland, WA (US)

(73) Assignee: Microsoft Corporation, Redmond, WA (US)

(21) Appl. No.: 14/291,997

(22) Filed: May 30, 2014

(51) Int. Cl. H04L 29/08

(52) U.S. Cl. CPC H04L 67/16; H04L 67/10

(57) ABSTRACT

A data center controller that maintains operation of at least one of its constituent headless hardware devices. An example of a headless hardware device may be server, or a server blade. The data center controller identifies that a particular headless hardware device has an unmanaged state, which means the headless hardware device is non-bootable without further code. In response, the data center controller decides which of one or more operational supplements are to be installed on the headless hardware device. The one or more operational supplements are sufficient at least to transition the headless hardware device from an unmanaged state to a managed state, thus allowing the headless hardware device to complete the boot process. The operational supplement(s) might include a management interface through which the data center controller might provide further management instructions to the headless hardware device.

### BACKGROUND

Computing systems have revolutionized the way people communicate, do business, and play, and has enabled what is now termed the “information age”. In modern computing, much of the infrastructure that supports computing activity is not local to the user, but is instead “in the cloud”. Cloud computing is enabled in large part by data centers, in which a large quantity of computing resources are located. Such computing resources may include, for example, processing, storage, and network resources. Client machines communicate with the data centers to take advantage of these computing resources.

Data centers are typically composed of a large quantity of headless hardware devices. A “headless” hardware device is a device or computing system that does not have a monitor, keyboard, or any traditional means for receiving input from a user and providing input to a user. Instead, the headless hardware device simply processes information and communicates with other network nodes. As an example, a headless hardware device might be a server rack, a server console, a server blade, or the like.

The task of managing the large quantity of headless hardware devices can be daunting indeed. Data centers can be quite large employing thousands or even millions of such headless hardware devices. Each headless hardware device should be equipped with the proper software and firmware in order to accomplish that task that it is engaged in. Appropriate drivers, software, data, and the like, should be loaded into the correct headless hardware device.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the operation of a data center controller to maintain operation of a headless hardware device. An example of a headless hardware device may be server, or a server blade. The data center may have multiple headless hardware devices, and may perhaps apply the method to maintain operation of multiple of the headless hardware devices.

The data center controller identifies that a particular headless hardware device has an unmanaged state, which means the headless hardware device is non-bootable without further code. As an example, when the headless hardware device is in the process of attempting to boot, the headless hardware device may issue a notification from which it can be understood that the headless hardware device is in an unmanaged state.

In response, the data center controller decides which of one or more operational supplements are to be installed on the headless hardware device. As an example, the operational supplements may be software entities such as, but not limited to, modules, components, objects, applications, drivers, engines, methods, functions or the like. The operational supplements might also be firmware entities such as firmware images. Regardless, the one or more operational supplements are sufficient at least to transition the headless hardware device from an unmanaged state to a managed state, thus allowing the headless hardware device to complete the boot process. As an example, the one or more operational supplements might include a management interface through which the data center controller might provide further management instructions to the headless hardware device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 abstractly illustrates a data center environment in which a data center includes headless hardware devices; and

FIG. 3 illustrates a flowchart of a method for a data center controller to maintain operation of a headless hardware device within a data center that has a plurality of headless hardware devices.

### DETAILED DESCRIPTION

At least some embodiments described herein relate to the operation of a data center controller to maintain operation of a headless hardware device. An example of a headless hardware device may be server, or a server blade. The data center may have multiple headless hardware devices, and may perhaps apply the method to maintain operation of multiple of the headless hardware devices.

The data center controller identifies that a particular headless hardware device has an unmanaged state, which means the headless hardware device is non-bootable without further code. As an example, when the headless hardware device is in the process of attempting to boot, the headless hardware device may issue a notification from which it can be understood that the headless hardware device is in an unmanaged state.

In response, the data center controller decides which of one or more operational supplements are to be installed on the headless hardware device. As an example, the operational supplements may be software entities such as, but not limited to, modules, components, objects, applications, drivers, engines, methods, functions or the like. The operational supplements might also be firmware entities such as firmware images. Regardless, the one or more operational supplements are sufficient at least to transition the headless hardware device from an unmanaged state to a managed state, thus allowing the headless hardware device to complete the boot process. As an example, the one or more operational supplements might include a management interface through which the data center controller might provide further management instructions to the headless hardware device.

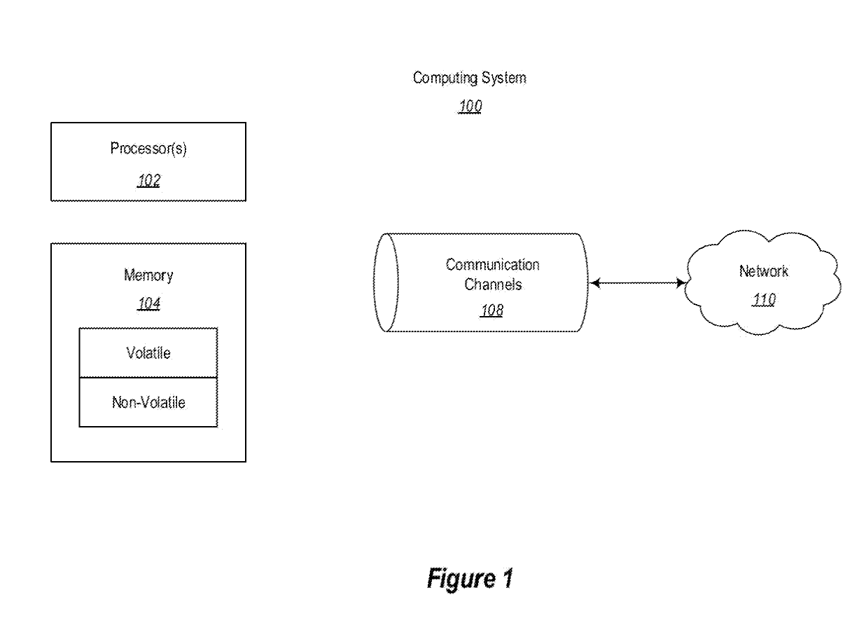

Some introductory discussion of a computing system will be described with respect to FIG. 1. Then, example environments, methods and supporting architectures will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media include RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

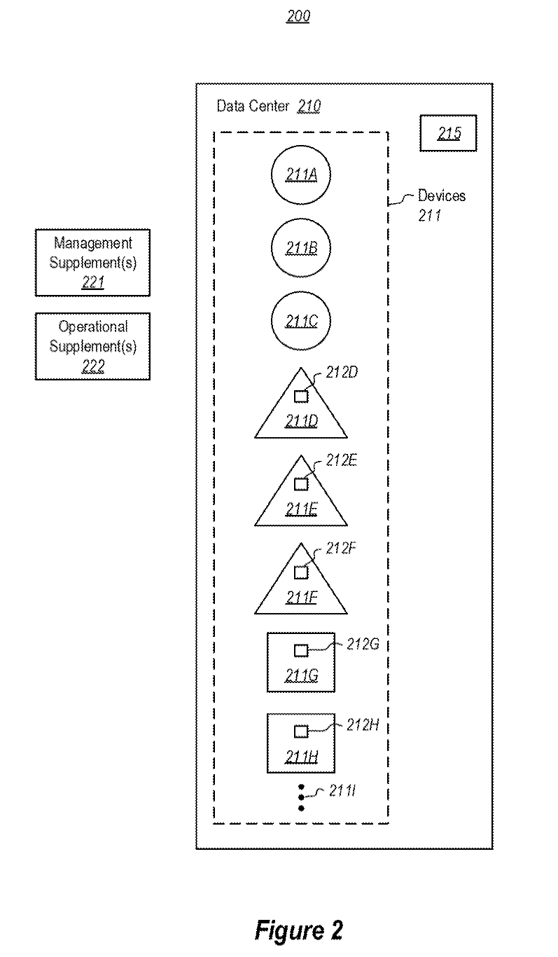

FIG. 2 abstractly illustrates a data center environment 200 in which a data center 210 includes headless hardware devices 211. The term “headless” hardware device is a term of art and refers to a device or computing system in which there are no mechanism for interacting directly with a user. For instance, there are no monitors, speakers, cameras, keyboards, pointer devices, or any other user input or user output devices connected directly to the headless hardware device. Examples of headless hardware devices are server computing systems such as server racks, server blades, or the like.

The headless hardware devices 211 are illustrated as including eight headless hardware devices 211A, 211B, 211C, 211D, 211E, 211F, 211G and 211H. However, the ellipses 2111 represent that there may be any number of headless hardware devices within a data center. In a typical data center, there may be hundreds or thousands of headless hardware devices. However, there may even be millions of headless hardware devices in very large data centers, whether currently existing or to be established in the future. A lower than typical number of headless hardware devices is illustrated in FIG. 2 for mere purposes of simplicity, and therefore clarity, in describing the broader principles herein.

In the illustrated embodiment, three of the head headless hardware devices 211 are illustrated as being in an unmanaged state, as symbolized by those headless hardware devices 211A, 211B and 211C represented as a circle. In this description and in the claims, an “unmanaged” device, or a device in an “unmanaged state” is a hardware device that cannot be booted (i.e., is “non-bootable”) without further code. The remaining headless hardware devices 211D, 211E, 211F, 211G and 211H are bootable and thus in a managed state, and further include a management interface 212D, 212E, 212F, 212G and 212H, respectively.

The data center 210 includes a data center controller 215 that is capable of communicating various commands to any of the headless hardware devices via its corresponding management interface. If the headless hardware device does not have a corresponding management interface (such as for headless hardware devices 211A, 211B and 211C), then the data center controller 215 may only communicate a limited amount with the corresponding headless hardware device.

Of the managed headless hardware devices, some of the headless hardware devices 211D, 211E and 211F are to be subject to one or more upgrades, and are abstractly represented using triangles in FIG. 2. Two of the headless hardware devices 211G and 211H are managed as well as fully upgraded, and are abstractly represented using squares in FIG. 2.

The ellipses 2111 also symbolize that the number of unmanaged headless hardware devices (abstractly represented by circles in FIG. 2) amongst the headless hardware devices 211 may be as few as zero, and as many as all of the headless hardware devices 211 in the data center, and anywhere in between. Furthermore, the set of unmanaged headless hardware devices may vary as unmanaged headless hardware devices become managed, and as managed headless hardware devices become unmanaged.

Similarly, the ellipses 2111 also symbolize that the number of managed, but to-be-upgraded, headless hardware devices (abstractly represented by triangles in FIG. 2) amongst the headless hardware devices 211 may be as few as zero, and as many as all of the headless hardware devices 211 in the data center, and anywhere in between. Furthermore, the set of managed, but to-be-upgraded headless hardware devices may vary as headless hardware devices are upgraded, and as new upgrades become available.

Finally, the ellipses 2111 symbolize that the number of managed and fully upgraded headless hardware devices (abstractly represented by squares in FIG. 2) amongst the headless hardware devices 211 may be as few as zero, and as many as all of the headless hardware devices 211 in the data center, and anywhere in between. Furthermore, the set of managed and fully upgraded headless hardware devices may vary as headless hardware devices are upgraded, and as new upgrades become available.

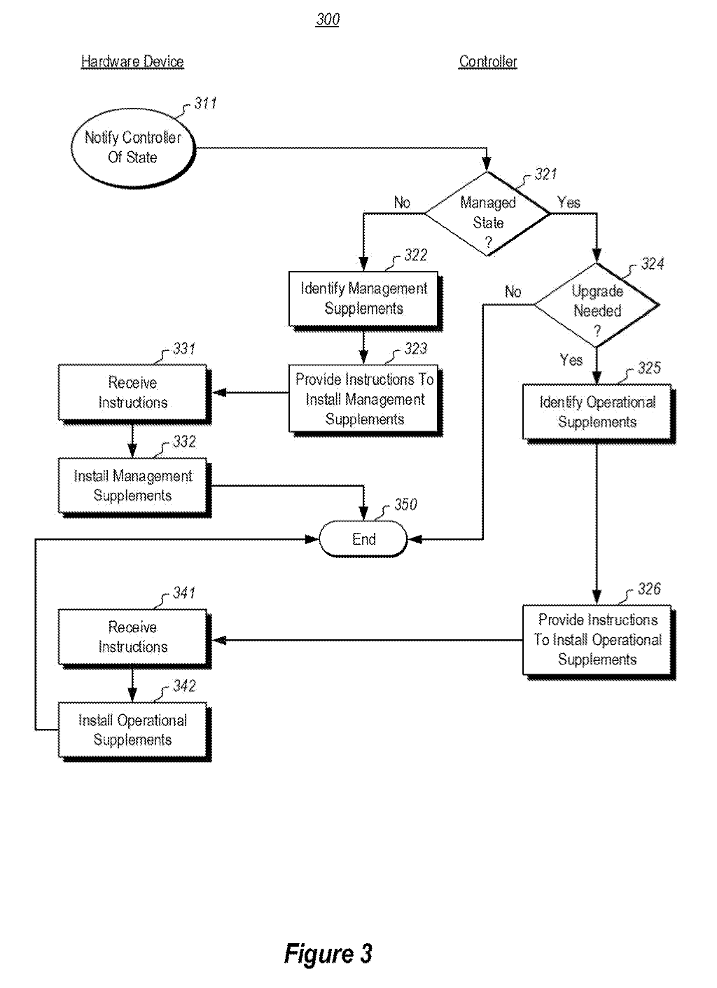

FIG. 3 illustrates a flowchart of a method 300 for a data center controller to maintain operation of a headless hardware device within a data center that has a plurality of headless hardware devices. As the method 300 may be performed within the data center environment 200 of FIG. 2, the method 300 will be described with frequent references to both FIGS. 2 and 3. Some of the acts of the method 300 are performed by a headless hardware device (e.g., headless hardware device 211A of FIG. 2), and are illustrated in the left column of FIG. 2 under the heading “Hardware Device”. Some of the acts of the method 300 are performed by the data center controller (e.g., the data center controller 215 of FIG. 2), and are illustrated in the right column of FIG. 2 under the heading “Controller”.

The method 300 includes a particular headless hardware device notifying that the headless hardware device has a particular state (act 311). The method 300 may be performed at least under some circumstances when a headless hardware device that provides notice to the data center controller of a state of the headless hardware device. For instance, with reference to FIG. 2, in a first example that follows, the headless hardware device 211A provides notice to the data center controller 215 of a state of the headless hardware device 211A, thus initiating the method 300 with respect to the headless hardware device.

In some embodiments described herein, one general state that may be communicated is the unmanaged state, in which the device is not bootable without further code. Another general state is managed state, in which the device is bootable without further code. In any case, the controller receives the notification from the headless hardware device, and determines whether or not the headless hardware device is in a managed state (decision block 321). For instance, in the first example, the data center controller 215 would use the notification to determine that the headless hardware device 211 is in an unmanaged state (“No” in decision block 321). Recall that the circles in FIG. 2 abstractly represent those headless hardware devices that are initially in an unmanaged state.

In one embodiment described herein, each headless hardware device initiates the boot process in an unmanaged state, and automatically notifies the controller of its unmanaged state. In that case, the notification is a boot-time notification, and the headless hardware device would require further software to be provided in order to complete the boot process.

Based on the identified state, the controller then decides (acts 322 and 325) what one or more operational supplements are to be added to the headless hardware device In the case of the identified state being the unmanaged state (“No” in decision block 321), the controller decides (act 322) what one or more management supplements are to be added to the headless hardware device. The one or more management supplements are structured such that, when installed on the particular headless hardware device, the one or more management supplements provide the particular headless hardware device with a management interface that transitions the particular headless hardware device to a managed state. For instance, in the first example with respect to FIG. 2, the data center controller 215 decides what one or more management supplements are to be added to the headless hardware device 211A upon being notified that the headless hardware device 211A is in an unmanaged state.

In this description and in the claims, an “operational supplement” is software or firmware that did not exist on the headless hardware device prior to the notification of act 311. In this description and in the claims a “management supplement” is a type of operational supplement that allows the headless hardware device to complete the boot process. In some embodiments, the management supplement also allows the headless hardware device to also implement a management interface, which the data center controller may then communicate through to provide further instructions to the headless hardware device.

Optionally, the controller may also use the identity of the one or more operational supplements to decide a methodology for how the one or more operational supplements are to be added to the headless hardware device. For instance, the methodology might involve the data center controller providing a firmware image, or a software component from within the data center, or may involve obtaining the one or more operational supplements from external to the data center using some Uniform Resource Identifier (URI). In FIG. 2, for instance, the one or more management supplements 221 are illustrated as external to the data center 210, although the principles described herein are compatible with solutions in the one or more management supplements are located internal to the data center 210 and/or are distributed between the data center 210 and a network node external to the data center 210.

The data center controller then provides (act 323) instructions to the headless hardware device. The instructions are structured to cause the particular headless hardware device to install the one or more management supplements. If there is a methodology for acquiring and/or installing the one or more management supplements, the data center controller may provide instructions regarding that methodology also. In any case, the instructions are sufficient to cause the headless hardware device to act install the management supplement(s).

Accordingly, the headless hardware device receives (act 331) the instruction to install one or more management supplements. The headless hardware device then response to the instructions by installing (act 332) the one or more operational supplements thereby causing the headless hardware device to transition from the unmanaged state to a managed state. Referring to FIG. 2, in the first example, the headless hardware device might transition from an unmanaged state (abstractly symbolized by a circle in FIG. 2) to a managed state (abstractly represented by a triangle or square in FIG. 2), and having a management interface through would the data center controller may further communicate with the headless hardware device.

In one embodiment, the method 300 is performed as described for an initial stage during boot-time of the headless hardware device. Then, the headless hardware device might initiate the method 300 a subsequent time in a managed state. For instance, the headless hardware device 211D might have obtained its managed state by an initial performance of the method 300 performed when the headless hardware device 211D had initially booted, much as already described for the first example with respect to the headless hardware device 211A. Subsequently, the headless hardware device 211D might again initiate the method 300 in a managed state (act 311).

In response, the data center controller determines that the headless hardware device is in the managed state (“Yes” in decision block 321). The data center controller further determines whether or not upgrades are needed for the headless hardware device (decision block 324). If no upgrades are needed (“No” in decision block 324), then the headless hardware device is in a managed state, and is in a fully upgraded state. Accordingly, the method 300 may end without updating the headless hardware device and the method 300 may end (act 350). Such is the case with headless hardware devices 211G and 211H, being in a managed and fully upgraded state as symbolized by the square.

On the other hand, if upgrades are needed (“Yes” in decision block 324), then the data center controller facilitates those upgrades as described herein. Such is the case with headless hardware devices 211D, 211E and 211F being in a managed, but to-be-upgraded state, as symbolized by the triangle. However, the management interface of the headless hardware device may be used to facilitate the upgrade. For instance, in response to the notification (act 311) from the headless hardware device 211D, the data center controller may use the management interface 212D to complete the upgrade process.

Specifically, in response to the notification (act 311), the data center controller determines that the headless hardware device is in a managed state (“Yes” in decision block 321), and that the headless hardware device is to be upgrade (“Yes” in decision block 324). In response, the data center controller identifies (act 325) one or more operational supplements that are to be installed on the headless hardware device. Furthermore, the data center controller provides (act 326) instructions for the headless hardware device to install the one or more operational supplements.

As an example, the operational supplements may be a software installation such as an operating system installation or application installation. The operational supplements might alternatively be a firmware update, a driver installation, an operating system update, or the like.

The instructions are structured to cause the particular headless hardware device to install the one or more operational supplements. If there is a methodology for acquiring and/or installing the one or more operational supplements, the data center controller may provide instructions regarding that methodology also. In any case, the instructions are sufficient to cause the headless hardware device to act install the operational supplement(s).

In FIG. 2, for instance, the one or more operational supplements 222 are illustrated as external to the data center 210. However, the principles described herein are compatible with solutions in the one or more management supplements are located internal to the data center 210 and/or are distributed between the data center 210 and a network node external to the data center 210.

Accordingly, the headless hardware device receives (act 341) the instruction to install one or more operational supplements. The headless hardware device then responds to the instructions by installing (act 342) the one or more operational supplements thereby causing the headless hardware device. Referring to FIG. 2, in the first example, the headless hardware device might then transition from a to-be-upgrade state (abstractly symbolized by a triangle in FIG. 2) to a managed state (abstractly represented by a square in FIG. 2).

Thus, the principles described herein provide an effective mechanism to allow a data center controller to update headless hardware devices within the data center. Such a mechanism may be used to provide a management interface to the headless hardware device so as to transition from an unmanaged state to a managed state. The mechanism may also be used to update a managed headless hardware device via the management interface. Furthermore, the mechanism may be automated thus allowing updates to be performed wide-scale through many, most, or even all of the headless hardware devices in the data center.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a data center controller to maintain operation of a headless hardware device within a data center that has a plurality of headless hardware devices, the method comprising:
an act of identifying an unmanaged state of a headless hardware device of the plurality of headless hardware devices within the data center; and
an act of deciding, based on the identified state, what one or more operational supplements are to be added to the headless hardware device, the one or more operational supplements being at least sufficient to transition the headless hardware device from an unmanaged state to a managed state.

2. The method in accordance with claim 1, further comprising:
an act of providing instructions to the headless hardware device sufficient to cause the headless hardware device to act on the one or more operational supplements.

3. The method in accordance with claim 1, wherein the act of providing instructions to the headless hardware device occurs in an initial stage and at least one subsequent stage, one or more instructions provided during the initial stage being sufficient to provide the headless hardware device with a management interface, the management interface enabling the headless hardware device to receive one or more instructions provided by the data center controller in the at least one subsequent stage.

4. A method in accordance with claim 1, further comprising:
an act of deciding, based the identity of the one or more operational supplements, a methodology for how the one or more operational supplements are to be added to the headless hardware device.

5. A method in accordance with claim 1, wherein the one or more operational supplements is provided a firmware image.

6. The method in accordance with claim 1, the one or more operational supplements comprising a software installation.

7. The method in accordance with claim 1, the one or more operational supplements comprising a firmware update.

8. The method in accordance with claim 1, the one or more operational supplements comprising a driver installation or upgrade.

9. A method for a headless hardware device within a data center to go from an unmanaged state to a managed state, the method comprising:
an act of the headless hardware device notifying that the headless hardware device has an unmanaged state;
an act of the headless hardware device receiving an instruction to install one or more operational supplements, the received instruction being dispatched by a data center controller in response to the headless hardware device notifying of the unmanaged state; and
an act of the headless hardware device installing the one or more operational supplements in response to the instruction, thereby causing the headless hardware device to transition from the unmanaged state to a managed state.

10. The method in accordance with claim 9, the act of the headless hardware device notifying occurring automatically in response to the headless hardware device being booted up.

11. The method in accordance with claim 9, the one or more operational supplements comprising a first set of one of more operational supplements, the instruction to install the first set of one or more operational supplements being a first instruction, the method further comprising:
while the headless hardware device is in the managed state, an act of the headless hardware device receiving a second instruction to install a second set of one or more operational supplements; and
an act of the headless hardware device installing the second set of one or more operational supplements in response to the second instruction.

12. The method in accordance with claim 9, wherein the act of the headless hardware device receiving a second instruction is facilitated at least in part by the first set of one or more operational supplements.

13. A computer program product comprising one or more computer-readable storage media having thereon computer-executable instructions that are structured such that, when executed by one or more processors of a data center, cause a data center controller of the data centered to perform a method to maintain operation of a plurality of headless hardware devices, the method comprising:
for a particular headless hardware devices of the plurality of headless hardware devices, an act of determining that the particular headless hardware device is in an unmanaged state; and
an act of providing an instruction to install one or more management supplements to the particular headless hardware device,
the one or more management supplements structured such that, when installed on the particular headless hardware device, the one or more management supplements provide the particular headless hardware device with a management interface that transitions the particular headless hardware device to a managed state,
the instruction structured to cause the particular headless hardware device to install the one or more management supplements.

14. The computer program product in accordance with claim 13, the act of determining that the particular headless hardware device is in an unmanaged state being performed as a result of receiving a boot-time notification from the particular headless hardware device.

15. The computer program product in accordance with claim 14, the method performed for each of multiple of the plurality of headless hardware devices when the corresponding headless hardware device boots up to thereby issue a corresponding boot-time notification

16. The computer program product in accordance with claim 13, the one or more computer-executable instructions further structured so that the method further comprises:
an act of identifying one or more operational supplements that are to be installed on the particular headless hardware device; and
an act of providing an instruction through the management interface of the particular hardware device for the particular headless hardware device to install one or more operational supplements.

17. The computer program product in accordance with claim 16, the one or more operational supplements comprising a software installation.

18. The computer program product in accordance with claim 16, the one or more operational supplements comprising a firmware update.

19. The computer program product in accordance with claim 16, the one or more operational supplements comprising a driver installation or upgrade.

20. The computer program product in accordance with claim 16, the method further comprising:
an act of deciding, based the identity of the one or more operational supplements, a methodology for how the one or more operational supplements are to be added to the headless hardware device.
